(19) United States
(12) Patent Application Publication
(10) Pub. No.: US 2007/0216168 A1
(43) Pub. Date: Sep. 20, 2007

(54) Locking Device For A Moving Element, Particularly For A Drum Of A Top-Loading Washing Machine

(76) Inventors: Michele Farano, Torino (IT); Giosue Capizzi, Buttigliera Alta (IT); Sabrina Bindocci, San Mauro Torinese Torino (IT)

Correspondence Address: SUGHRUE MION, PLLC, 2100 PENNSYLVANIA AVENUE, N.W., SUITE 800, WASHINGTON, DC, 20037, US

(21) Appl. No.: 11/576,600

(22) PCT Filed: Oct. 6, 2005
(86) PCT No.: PCT/EP05/55047

§ 371 Date: Apr. 3, 2007

(30) Foreign Application Priority Data
Oct. 8, 2004 (IT) TO2004A000691

(51) Int. Cl. E05C 19/06

(52) U.S. Cl. 292/89

(57) ABSTRACT

Locking device for a moving element, particularly for a drum of a top-loading washing machine. The locking device (20) for retaining a moving element (5) in a predetermined position, particularly a drum (5) of a top-loading washing machine (1) in a loading/unloading position of the drum (5), comprises a casing (21) in which is mounted a catch (22) which is slidable in a guided way between an outward position and a retracted position, in which it can, respectively, lock and release the moving element (5), and which is associated with first opposing resilient means (27) tending to move it to the outward position. The casing (21) also includes locking members (32, 33) which in an operating condition can move the catch (22) to the retracted position and retain it there, and release members (34) which in an operating condition can make the locking members (33) move to a release condition in which they allow the catch (22) to return to the outward position. The locking means (32, 33) and the release means (34) are associated, respectively, with first and second actuators (38, 60), which are capable of causing these means to move from an inoperative condition to their respective operating conditions.

The present invention relates to a locking device for a moving element, particularly for a drum of a top-loading washing machine.

In the operation of top-loading washing machines, it is convenient for the drum to be stopped, at the end of an operating or working cycle, in an angular position in which its opening essentially faces upwards, to facilitate loading and/or unloading operations.

An object of the invention is to provide a device for locking a moving element, particularly but not necessarily a drum of a top-loading washing machine, which is simplified, inexpensive, and highly reliable.

To achieve this object, the present invention proposes a locking device for retaining a moving element in a predetermined position, particularly for retaining a drum of a top-loading washing machine in a loading/unloading position of the drum, characterized in that it comprises a casing in which are mounted:
a catch slidable in a guided way between an outward position and a retracted position in which it is adapted, respectively, to lock and release the moving element, and which is associated with first opposing resilient means tending to move it to the outward position;
locking means for the catch, which in an operating condition are able to move the catch to the retracted position and retain it there;
release means for the catch, which in an operating condition are capable of making the locking means move to a release condition in which they allow the catch to return to the outward position; and
first and second actuator means, associated with the locking means and the release means respectively, and which are capable of causing these means to move from an inoperative condition to their respective operating conditions.

Further characteristics and advantages of the invention will be made clear by the following detailed description, which refers to the attached drawings provided purely by way of example and without restrictive intent, in which:

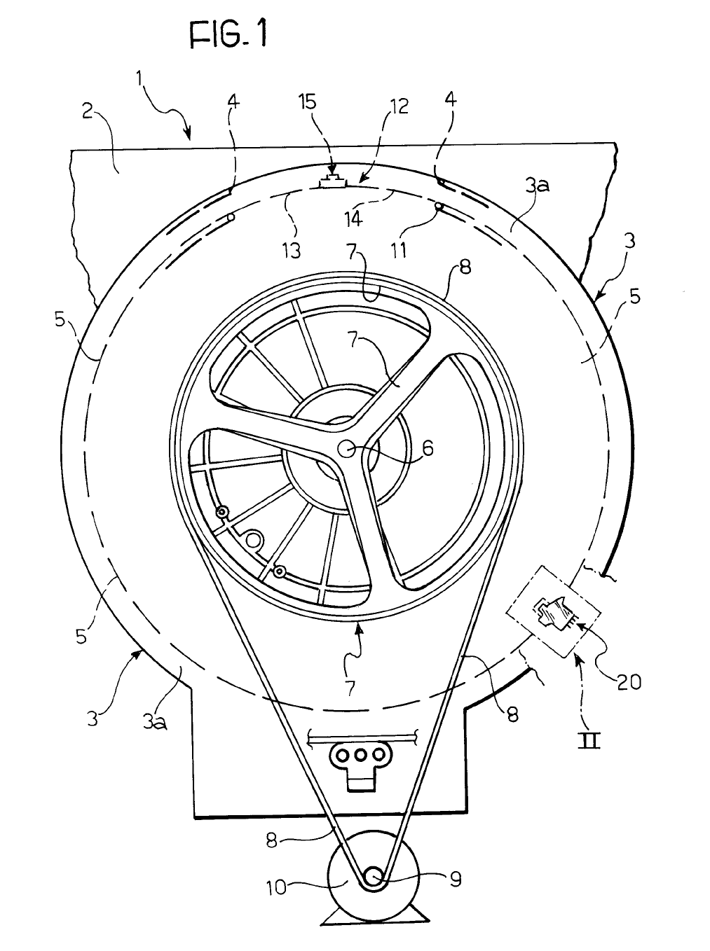

FIG. 1 is a schematic view in elevation of part of a washing machine comprising a locking device according to the invention;

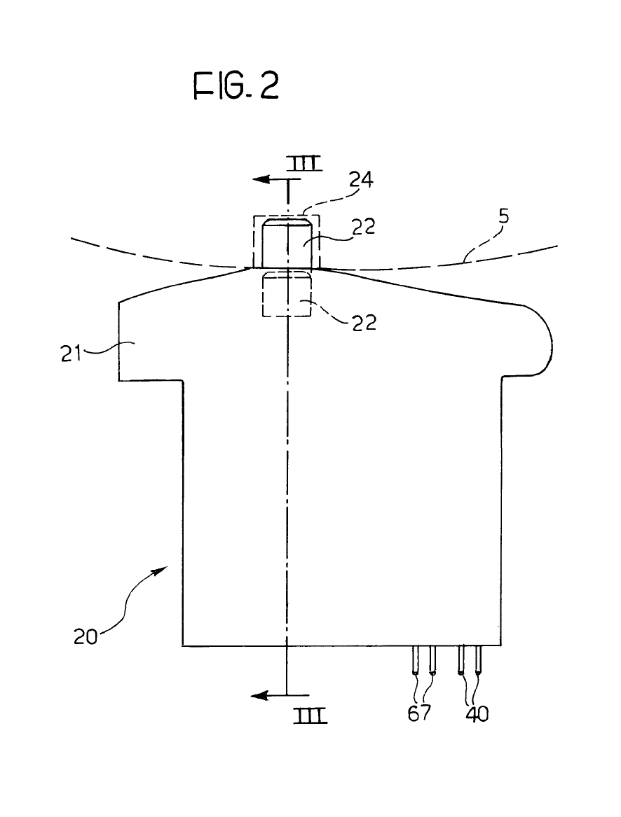

FIG. 2 is an enlarged view of the locking device shown in the frame indicated by II in FIG. 1 and having a catch in an outward position;

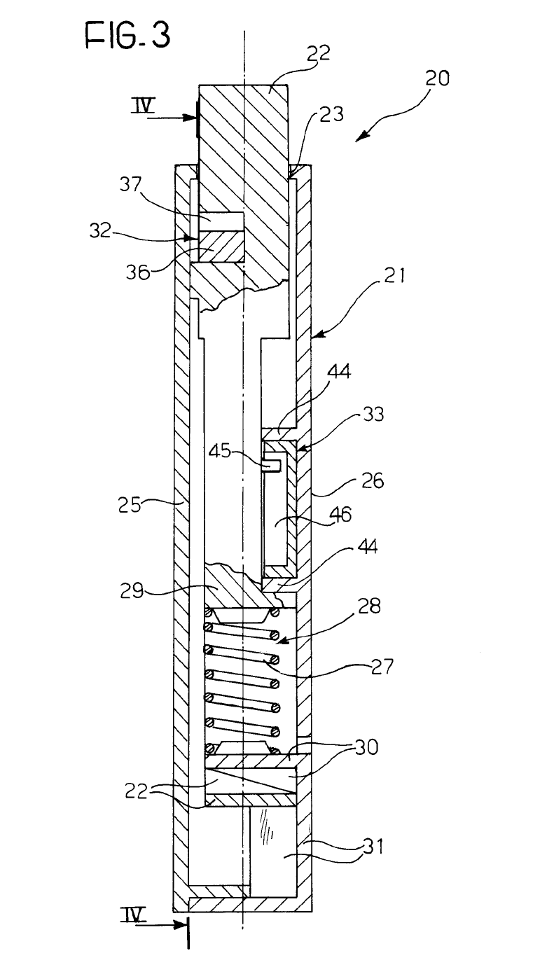

FIG. 3 is a sectional view of the locking device taken along the line III-III of FIG. 2;

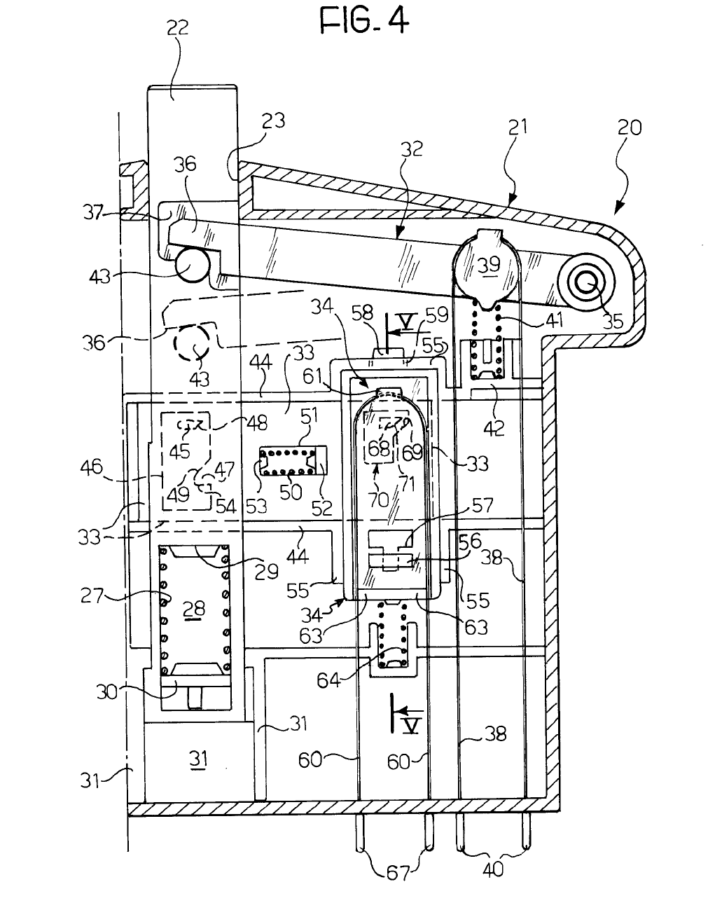

FIG. 4 is a partial sectional view of the locking device taken along the line IV-IV of FIG. 3;

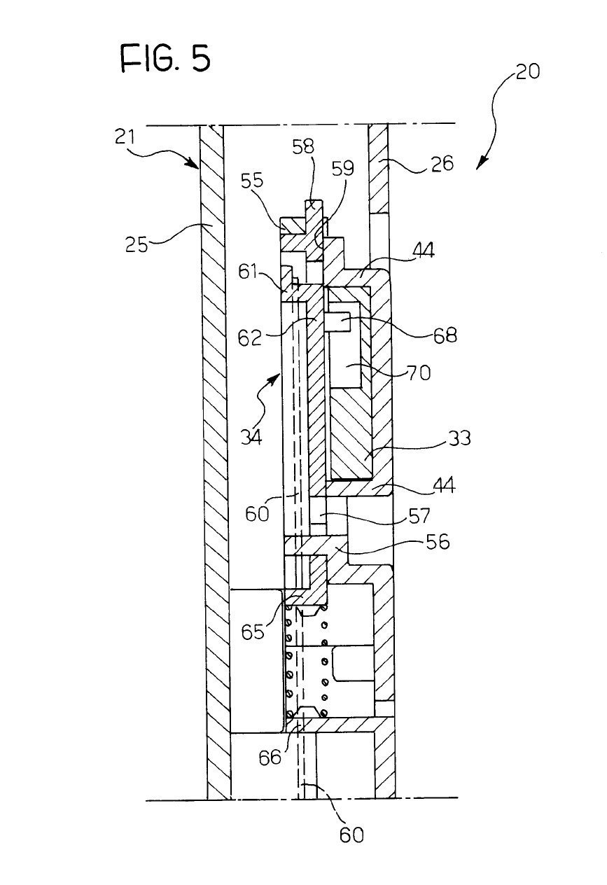

FIG. 5 is a partial sectional view of the locking device taken along the line V-V of FIG. 4.

The number 1 in FIG. 1 indicates the whole of a top-loading laundry processing machine. The machine 1 can be a washing machine, a drier, a washer-drier, or the like.

The machine 1 comprises a supporting structure 2 in which is mounted a processing chamber or tub 3 provided with a top opening 4 which is associated in a known way with a top closing hatch (not shown).

A drum 5, connected to a horizontal shaft 6, is mounted rotatably in the chamber or vessel 3.

A pulley 7 is fixed to one end of the shaft 6, and is connected by means of a transmission belt 8 to the shaft 9 of an electric motor 10 for moving the drum.

In a known way, the drum 5 has a peripheral opening 11 associated with a closing device 12, also of a known type, comprising for example a pair of hinged leaves 13 and 14 which can be joined together by means of a hooking mechanism 15.

The machine 1 comprises a locking device 20 for stopping and retaining the drum 5 at the end of an operating or working cycle in an angular position in which its loading/unloading opening 12 essentially faces upwards.

With reference in particular to FIG. 2, the locking device 20 comprises a casing 21 which can be fixed inside the processing chamber or tub 3, for example by means of fixing screws (not shown). The casing 21 encloses a catch 22 which is slidable from an active outward position (shown in solid lines in FIG. 2) to an inactive retracted position (shown in broken lines in FIG. 2) with respect to this casing 21 through an opening 23 (see FIGS. 3 and 4) facing the drum 5.

At the end of the operating cycle of the washing machine 1, the electric motor 10 is switched off and the drum 5 continues to rotate for a few instants due to inertia. In this condition, the locking device 20 tends to move the catch 22 to the outward position, in which it can stop the inertial movement of the drum 5, by engaging in a recess 24 present on the lateral surface of this drum 5. The recess 24 is located in a position such that the drum 5 is locked in a position in which its unloading/loading opening 11 faces upwards.

With reference in particular to FIG 3, the casing 21 preferably comprises two half-shells 25 and 26 which are snap-fitted together. The movement of the catch 22 from the outward position to the retracted position is opposed by an opposing spring 27, for example a helical compression spring. This spring 27 is housed in an aperture 28 formed within the catch 22 and one of its ends bears on a wall 29 of this aperture 28 while the other end bears on an inner bracket 30 of the casing 21. The bracket 30, which extends into the aperture 28, permits the guided sliding of the catch 22, jointly with the aperture 23 and end walls 31 (shown more clearly in FIG. 4) belonging to the half-shell 26 and contained between this bracket 30 and the end of the casing opposite the opening 23.

With reference in particular to FIG. 4, the casing 20 additionally contains a lever 32, a stop slider 33 and a release slider 34, shown in an inoperative condition corresponding to the outward position of the catch 22, the operation of these elements being described below.

The lever 32, having an end portion 36 housed in a recess 37 formed preferably in an intermediate part of the catch 22, is mounted rotatably about a pivot 35 in the casing 21, and is driven by an actuator 38, particularly of the shape memory wire type. These wires can change in a known way, when electric current flows through them, from a relaxed inoperative condition to a contracted operating condition, by reducing their length. After this flow of current is interrupted, the shape memory wires again extend to their maximum length, returning to the relaxed condition.

The actuator wire 38 is wound in a loop around a pin 39 carried by an intermediate portion of the lever 32. The free ends of the actuator wire 38 are connected to corresponding strip terminals 40 intended for connection to a control circuit (not shown) which can control the flow of electric current through this actuator wire 38.

A second opposing spring 41, for example a helical compression spring, bears on the lever 32 in the vicinity of the pin 39, this spring being fixed at its other end to a bracket 42 of the casing 21, and tending to rotate the lever 32 in the clockwise direction with respect to FIG. 4.

When the control circuit causes current to flow in the actuator wire 38, the latter is capable contracting, thus drawing the pin 39 downwards, and, consequently, moving the lever 32 to an operating condition by rotating it in the anticlockwise direction with respect to FIG. 4. Thus the end portion 36 is intended to push a projection 43 present in a wall of the recess 37 of the catch, thus pushing this catch 22 from the outward position to the retracted position. In FIG. 4, the end portion 36 and the projection 43 are shown in solid lines in the inoperative condition and in broken lines in the operating condition.

As shown in FIGS. 3 and 4, the stop slider 33 can be translated in a direction essentially orthogonal to that of the sliding of the catch 22 along guides 44 projecting into the inner part of the half-shell 26. The translation of the stop slider 33 can take place against the action of a return spring 50, for example a helical compression spring, housed in an aperture 51 formed within this stop slider 33. The return spring 50 is connected at one end to a third bracket 52, projecting from the half-shell 26 into the aperture 51, and at the other end to a wall 53 of the aperture 51, and tends to move this wall 53 towards the catch 22. This catch 22 also has a projection 45 located on the opposite side from the projection 43, in other words on the side facing the half-shell 26, and capable of interacting with a dog 47 projecting into a recessed portion 46 formed on a surface of the stop slider 33 facing towards this catch 22. The projection 45 and the dog 47 have inclined portions 48 and 49 respectively which are complementary to each other.

During a first part of the travel of the catch 22 from the outward position to the retracted position, the inclined portion 48 of the projection 45 acts on the complementary portion 49 of the dog 47, moving the stop slider 33 against the action of the return spring 50. When the projection 45 passes beyond the inclined portion 49 of the dog 47, the return spring 50 pushes the slider 33 towards a stop position, by bringing the wall 53 of the aperture 51 closer to the catch 22. In the stop position, the projection 45 bears on a shoulder 54 of the dog 47, thus retaining this catch 22 in the retracted position. In this condition, the combined action of the first and second opposing springs 27 and 41 does not enable the catch 22 to move from the retracted position to the outward position, since this movement is impeded by the fact that the projection 45 bears on the shoulder 54. In FIG. 4, the substantially cuplike release slider 34 is slidable in a direction essentially parallel to that of the movement of the catch 22, along guides 55 projecting from the half-shell 26 inside the casing 21. The sliding of the release slider 34 is additionally linked to the casing 21 by the interaction of a fourth T-shaped bracket 56, projecting from the half-shell 26, with a shaped opening 57 formed in this release slider 34, and by the interaction of a forward tooth 58 of said release slider 34 with a corresponding forward hole 59 present in the guides 55.

A third opposing spring 64, for example a helical compression spring, tends to oppose the movement of the release slider 34 away from the opening 23 of the casing 21, and bears on a terminal wall 65 (FIG. 5) of this slider 34 and on a fifth bracket 66 projecting from the half-shell 26 (FIG. 5) into the casing 21.

As shown also in FIG. 5, a release actuator 60, particularly a shape memory wire, is wound in a loop around a support 61 projecting from the recessed end 62 of the release slider 34, and the two ends of this wire actuator 60 pass through a pair of channels 63 formed in the lower end of the release slider 34 located at the opposite end to the support 61. As in the actuator 38, the ends of the shape memory wire 60 are connected to strip terminals 67 which project outside the casing 21 and can be connected to a control circuit capable of causing current to flow in this wire 60.

The release slider 34 has on its end opposite the support 61 a protuberance 68 intended to interact with an inclined bend 69 in the edge of a second recessed portion 70 formed in the stop slider 33 on the same side as the first recessed portion 46. The protuberance 68 also has an inclined portion 71 which can act on the bend 69 which is inclined in a complementary way to it, as described below.

When the control circuit causes current to flow in the release actuator wire 60, the latter can contract and bring the release slider 34 into an operating condition, moving it in a direction opposite to the opening 23. In this condition, during the travel of the release slider 34, the protuberance 68 pushes the edge of the second recessed portion 70 initially against the bend 69, thus moving the stop slider 33 against the action of the return spring 50, until this protuberance 68 moves beyond the bend 69 and brings the slider 33 from the stop position to a release position, moving the wall 53 of the aperture 51 away from the catch 22. In this position, the stop slider 33 enables the projection 45 of the catch 22 to be disengaged from the shoulder 54 of the dog 47. Thus the spring 27 can push the catch 22 from the retracted position to the outward position and the device 20 returns to the initial configuration shown in FIG. 4.

In other embodiments (not shown), the actuators 38 and 60 can conveniently comprise portions of a single shape memory wire.

Naturally, provided that the principle of the invention is retained, the forms of application and the details of embodiment can be varied widely from what has been described and illustrated purely by way of non-limiting example, the invention extending to all embodiments which achieve the same usefulness by using the same innovative principles.

1. Locking device (20) for retaining a moving element (5) in a predetermined position, particularly a drum (5) of a top-loading washing machine (1) in a loading/unloading position of the drum (5), characterized in that it comprises a casing (21) in which are mounted
a catch (22) slidable in a guided way between an outward position and a retracted position in which it is adapted, respectively, to lock and release the moving element (5), and which is associated with first opposing resilient means (27) tending to move it to the outward position;
locking means (32, 33) for the catch, which in an operating condition are able to move the catch (22) to the retracted position and retain it there;
release means (34) for the catch, which in an operating condition are capable of making the locking means (33) move to a release condition in which they allow the catch (22) to return to the outward position; and
first and second actuator means (38, 60), associated with the locking means (32) and the release means (34) respectively, and which are capable of causing these means to move from an inoperative condition to their respective operating conditions.

2. Locking device (20) according to claim 1, wherein the first and second actuator means comprise respective actuator members (38; 60) which, when an electric current flows through them, are adapted to change from an elongate condition, in which the corresponding locking or release means (32; 34) are in the inoperative condition, to a contracted condition, in which the corresponding locking or release means (32; 34) are in the aforesaid operating condition.

3. Locking device (20) according to claim 2, wherein the actuator members (38, 60) of the locking and release means (32, 34) comprise at least one shape memory wire.

4. Locking device (20) according to claim 3, wherein the actuator members (38, 60) of the locking and release means (32, 34) comprise two portions of a single shape memory actuator wire.

5. Locking device (20) according to claim 1, wherein the release members comprise a lever (32) pivoted on the casing (21) and capable of interacting with the catch (22) to move it from the outward position to the retracted position against the action of opposing resilient members (27, 41).

6. Locking device (20) according to claim 5, wherein the locking means additionally comprise a stop slider (33) which is movable with respect to the casing (21) and is pushed by resilient return means (50) towards a stop condition in which it can retain the catch (22) in the retracted position.

7. Locking device (20) according to claim 6, wherein the release means comprise a release slider (34) which is movable with respect to the casing (21) and which is adapted to push the stop slider (33), against the action of further opposing resilient means (64), into a release condition which allows the catch (22) to return to the outward position.

8. Locking device (20) according to claim 5, wherein a first actuator wire (38) is connected to an intermediate portion (39) of the lever (32).

9. Locking device (20) according to claim 5, wherein an end portion (36) of the lever (32) is housed, preferably with a degree of play, in a recess (37) formed in the catch (22).

10. Locking device (20) according to claim 6, wherein the stop slider (33) is guided by the casing (21) so that it is movable in a direction essentially perpendicular to that of the movement of the catch (22).

11. Locking device (20) according to claim 7, wherein the stop slider (34) is guided by the casing (21) so that it can be translated in a direction essentially parallel to that of the movement of the catch (22).

12. Locking device (20) according to claim 11, wherein a second actuator wire (60) is connected to a portion (61) of the release slider (34).

13. Locking device (20) according to claim 5, wherein the catch (22) has a projection (45) capable of interacting with a retaining member (47) of the stop slider (33).

14. Locking device (20) according to claim 13, wherein the projection (45), during a first portion of the travel of the catch (22) from the outward position to the retracted position, is adapted to act on the retaining member (47), pushing the stop slider (33) towards the release condition against the action of the aforesaid resilient return means (50), and during a second portion of the said travel of the catch (22), the projection (45) being capable of passing beyond said retaining member (47) and being locked against it as a result of the combined action of the said first resilient opposing means (27) and the resilient return means (50) associated with the stop slider (33).

15. Locking device (20) according to claim 7, wherein the release slider (34) has a protuberance (68) capable of interacting with an actuating formation (69) of the stop slider (33).

16. Locking device (20) according to claim 15, wherein, during a portion of the travel of the release slider (34) towards the operating condition, the protuberance (68) of the release slider (34) is capable of acting on the actuating formation (69) of the stop slider (33), pushing this stop slider (33) towards the release condition against the action of the associated resilient return means (50).

17. Top-loading washing machine (1) comprising a processing tub or chamber (3) including a drum (5) rotated by an electric motor (10), this machine (1) being characterized in that it comprises a locking device (20) for this drum (5).
